(19) United States
(12) Patent Application Publication
(10) Pub. No.: US 2011/0154577 A1
(43) Pub. Date: Jun. 30, 2011

(54) INTEGRATED TIRE REPAIR MULTI TOOL WITH FOLDING PLIERS

(76) Inventor: Cormac Eubanks, (US)

(21) Appl. No.: 12/651,404

(22) Filed: Dec. 31, 2009

(51) Int. Cl. B25F 1/04; B25B 7/22

(52) U.S. Cl. 7/100; 7/128; 81/15.7

(57) ABSTRACT

An improved tire repair tool having a pair of pliers, with integrated cutters, a rasp for cleaning a tire puncture, a tool for inserting a cylindrical tire plug, and a means to store tire plugs within the assembly. The nominally channel shaped handles of the pliers have first and second ends. The first end of the handles are pivotally mounted to a pair of plier jaws which can be used to remove debris from a tire. The rasp and the means for inserting tire plugs are pivotally mounted to to the second end of one of the handles and can be moved between a stowed position and open position. The rasp and tool for inserting tire plugs are lockable in the stowed and open position in such a way to allow the rasp and insertion tool to rotate into a deployed position where they can be used. The second handle contains a means to store tire plugs.

### CROSS REFERENCE TO RELATED APPLICATIONS

None

### FEDERALLY SPONSORED RESEARCH

None

### SEQUENCE LISTING

None

### FIELD OF INVENTION

The invention relates to tools for repairing holes in pneumatic tires, specifically to tools for inserting repair plugs into tubeless tires from the outside without the need to remove the tire from the rim on which it is mounted.

### BACKGROUND OF THE INVENTION

### Prior Art

Repairing a tubeless car or motorcycle tire while the tire is still attached to the wheel is a critical task when one is on the road. This involves several steps. First, the user must remove the item which caused the puncture (nail, screw, etc.) from the tire. Secondly, the user must clean the puncture of any additional debris so that the tire plug seats properly. Next, one must insert the plug, lastly the user must trim the excess plug material.

Most tire repair tools in the prior art contain the means to clean a hole in a tire and to insert a plug to fill the hole. There are two problems with the currently available tools and kits. First, on most kits the tool to clean the hole and the tool to insert the plug are separate items meaning the individual tools can be lost or misplaced. This is less convenient than an integrated solution in which all the components are attached to one another. Secondly, none of the available kits include either a method of extracting the debris that punctured the tire, nor the means to trim the excess plug after it has been inserted. Trimming the excess plug material is critical in tire repair so that the plug does not work itself out while the tire is spinning. Having the means to trim the excess plug material integrated into the tool results in a safer repair.

U.S. Pat. No. 6,170,361 (Yates) All in One Tire Repair Tool has the means to insert a plug and stores the plugs in the handle, but has no means to remove debris from the tire nor a means to trim the excess plug material after the plug is inserted, nor a means to rasp the puncture.

U.S. Pat. No. 4,930,377 (Lester) Tire Repair Kit contains the means to install the plug and to expand the puncture if necessary, but the different tools must be interchanged manually which is inconvenient. Additionally, as separate components, the individual parts can be lost. Also no means is provided in this example to clean the puncture, nor to trim the excess plug material after insertion.

U.S. Pat. No. 3,783,715 (Niconchuk) Tire Repair Tools pertains to the means to insert a plug into a puncture, but contains no means to clean the puncture, nor to trim the excess plug material after insertion.

U.S. Pat. No. 5,515,751 (Lee) is another tool that has the means to insert a plug in a tire, but but contains no means to clean the puncture, nor to trim the excess plug material after insertion.

U.S. Pat. No. 5,033,140 (Chen et al) Multipurpose Combination Tool contains a the means to rasp the puncture and to install the plug, but these tools must be removed from the hollow handle of the pliers and the plug inserter/rasp must be inverted in another handle to use both used which is very inconvenient and leaves multiple parts to be lost. Also this tool has pliers, but no wire cutter to trim the excess plug material after insertion.

There is much prior art around folding multi-tools in which the handles fold around the plier jaws, but none of the prior art contains any tools in the handles for repairing a tire. U.S. Pat. Nos. 5,697,114 (McIntosh et. al.) Folding Multi-Tool, 4,744,272 (Leatherman) Foldable Tool, 4,238,862 (Leatherman) Pocket Multipurpose Tool, and 5,963,999 (Gardiner et. al) Multi-Purpose Folding Tool are all folding multi tools but none contain the means to repair a tire.

### SUMMARY

A tire repair plug installation tool that can be used from the outside without requiring the tire to be removed from the rim upon which it is mounted. A folding all-in-one tool which contains tools required to effect a repair in a tubeless tire including removing tire debris, cleaning the puncture, installing a plug and trimming the plug excess material. The tool also stores repair plugs within the assembly.

### DRAWINGS

### Figures

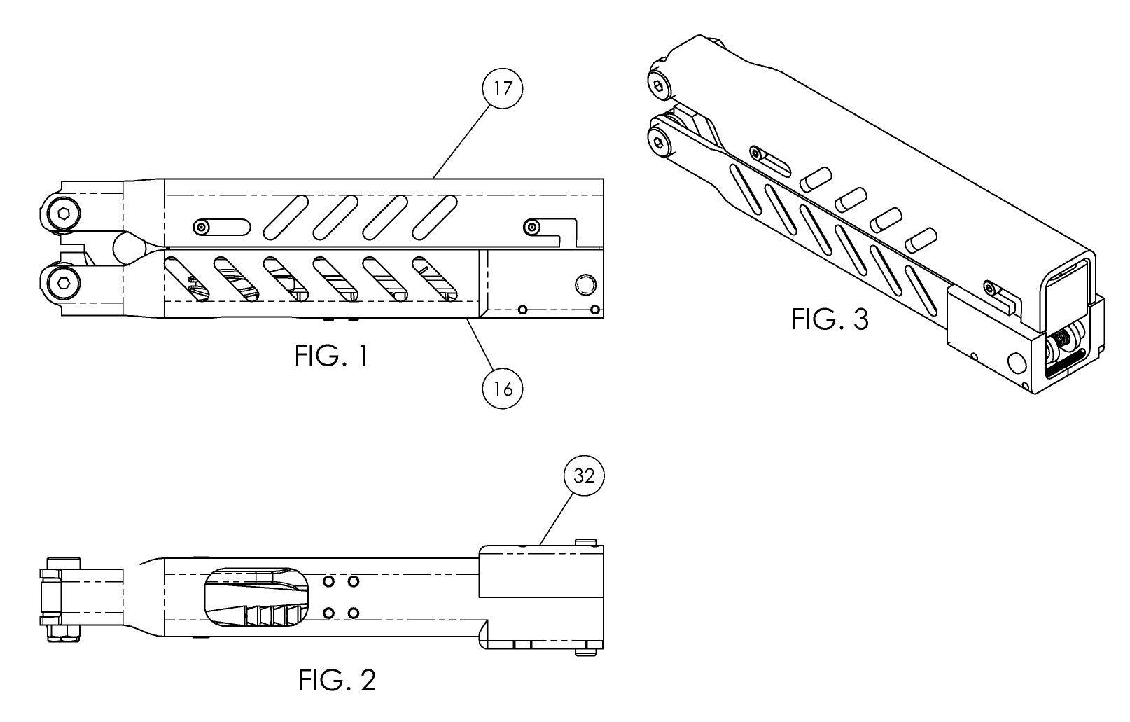

FIG. 1 is a side view of the tool in the closed position with the rasp and the fork in the retracted position.

FIG. 2 is a top view of the tool in the closed position with the rasp and the fork in the retracted position.

FIG. 3 is an isometric view of the tool in the closed position with the rasp and the fork in the retracted position.

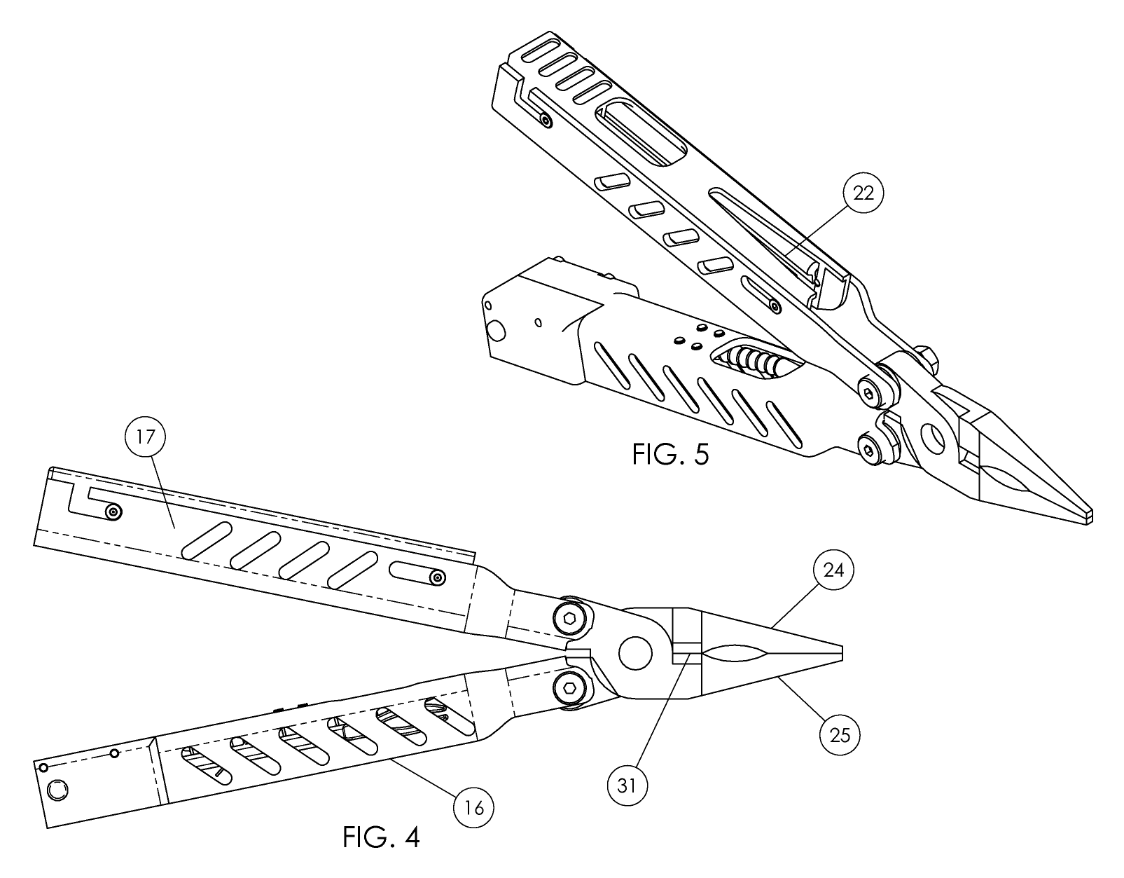

FIG. 4 is a side view of the tool in the open position with the rasp and the fork in the retracted position.

FIG. 5 is an isometric view of the tool in the open position with the rasp and the fork in the retracted position.

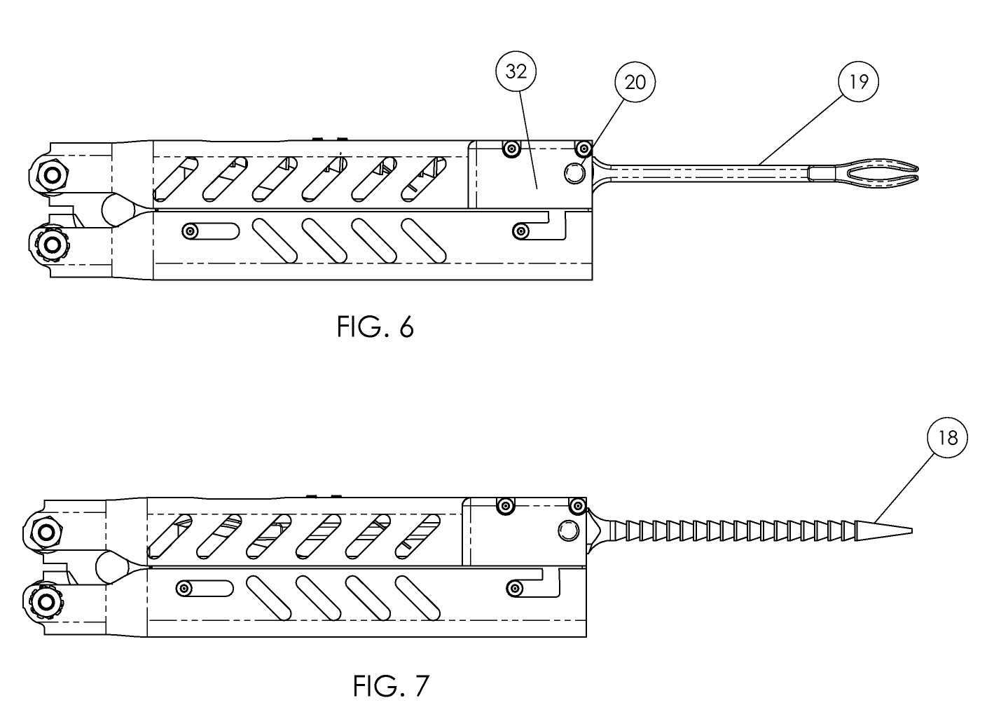

FIG. 6 is a side view of the tool in the closed position with the fork in the deployed position and the rasp in the retracted position.

FIG. 7 is a side view of the tool in the closed position with the rasp in the deployed position and the fork in the retracted position.

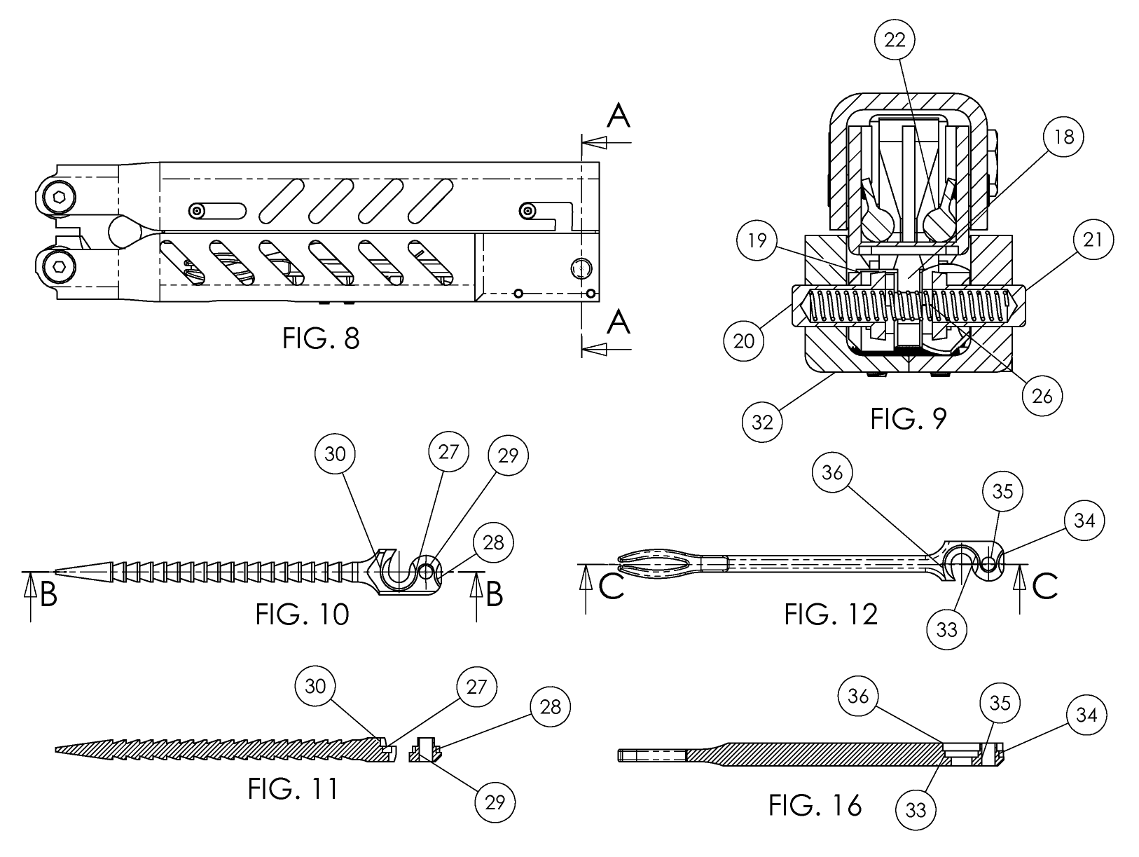

FIG. 8 is a side view of the tool in the closed position with the rasp and the fork in the retracted position showing the location of the section View 9.

FIG. 9 is a cross section through the central axis of the release button showing the mechanism which locks the tools in the closed position.

FIG. 10 is a side view of the rasp tool showing the U-shaped pocket and counterbore locking features.

FIG. 11 is a section view of the rasp tool showing the depth of the u-shaped pocket and the counterbored locking holes

FIG. 12 is a side view of the fork tool showing the U-shaped pocket and counterbore locking features.

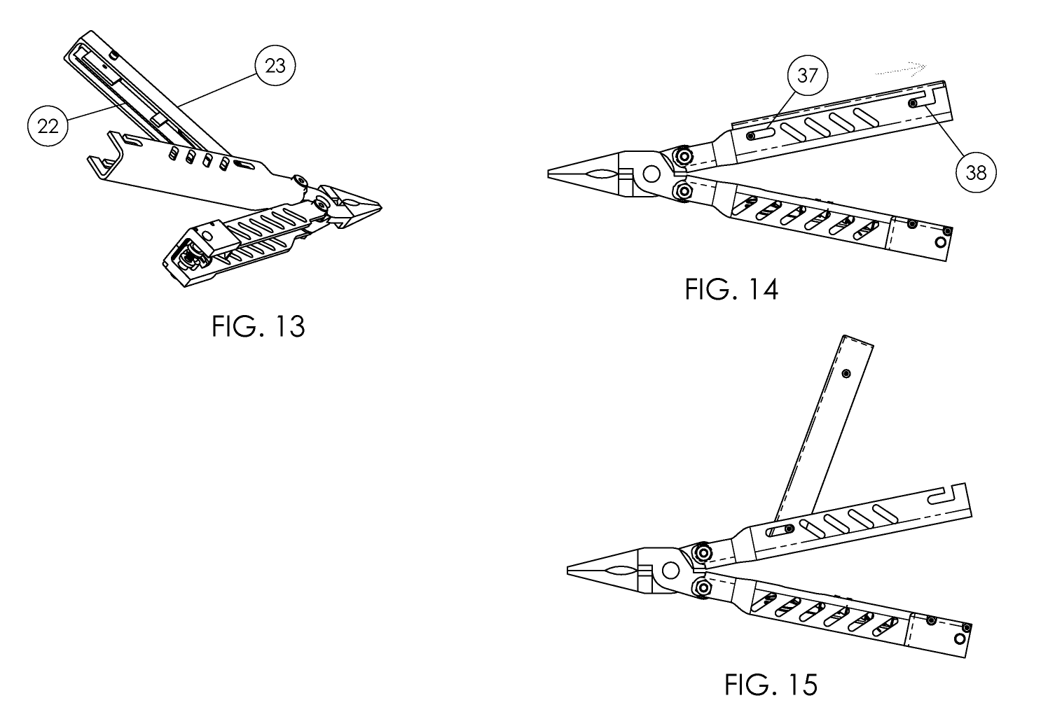

FIG. 13 is an isometric view of the tool in the open position and the plug holding tray in the open position so that the plugs can be removed

FIG. 14 is a side view of the tool in the open position with an arrow indicating where the user can slide the tray into the unlocked position allowing it to pivot to the open position.

FIG. 15 is a side view of the tool in the open position with the plug holder is the open position so that the plugs can be removed

### DRAWINGS

### Reference Numerals

16. Handle, Tire Tools
17. Handle, Plug Holding
18. Rasp
19. Fork
20. Button, Locking, Fork
21. Button, Locking, Rasp
22. Plug, Tire
23. Tray, Tire Plug Holding
24. Plier Half, First
25. Plier Half, Second
26. Spring, Compression
27. Locking counterbore pocket, deployed position, rasp
28. Locking counterbore pocket, stowed position, rasp
29. Hole, Pivot Axis, rasp
30. Pocket, U-shaped, rasp
31. Cutter, Tire Plug
32. Cap, Handle
33. Locking counterbore pocket, deployed position, fork
34. Locking counterbore pocket, stowed position, fork
35. Hole, Pivot Axis, fork
36. Pocket, U-shaped, fork
37. Slot, straight
38. Slot, L-Shaped

### DETAILED DESCRIPTION

### First Embodiment

An all-in-one tire repair tool for insertion of a plug into an injury in a tubeless tire. The tool comprises two nominally channel-shaped handles (16&17). Pliers comprising first and second plier halves (24&125) pivotally mounted to each other, with said plier halves being pivotally mounted to said first ends of said handles; and wherein said folding multi-tool is foldable between a closed, compact configuration in FIG. 1. and an opened, extended configuration for operating said pliers in FIG. 4. The pliers are used to remove the debris (nail, screw, etc) from the damaged tire.

The first of the handles, Handle, Tire Tools (16) contains nested within the open side a Rasp (18) which is pivotally mounted to the second end of said handle. The rasp, when in the deployed position in FIG. 7 is used to clean a puncture in a tire to ensure the plug, once inserted, remains in the tire. The Handle, Tire Tools also contains a fork (19) also pivotally mounted to the second end of the handle. The fork, when in the deployed position in FIG. 6 can be used to insert the nominally cylindrical tire plug by inserting the plug between the tines of the fork, inserting the fork and plug into the puncture then quickly removing the fork, leaving the plug in place in a folded orientation. In this embodiment, the Rasp and Fork are sandwiched in the handle between the Handle, Tire Tools and the Cap, Handle (32). The Cap, Handle as a separate part from the Handle, Tire Tools allows the tool to be assembled.

The Rasp (18) contains a U-shaped pocket (30) at the ends of which contain a pair of deeper countersunk pockets as shown in FIG. 10 and shown in cross section in FIG. 11. With the rasp in the stowed position, Button, Rasp, Locking (21) is held in in a nominally outward position in a counterbored pocket (28) by a compression spring (26). With this button in this outward position the rasp is unable to rotate around the pivot axis. To release the rasp, the user pushes the Button, Locking, Rasp (21) inward which moves the button out of the counterbored pocket into a shallower u-shaped pocket (30). The rasp is then able to rotate about the pivot axis (29). Once the rasp rotates into the deployed position the button is forced outward by the compression spring into the locking counterbore pocket (27) locking the rasp in the deployed position which prevents the rasp from rotating during use while cleaning the injury.

The Fork (19) contains a U-shaped pocket (36) at the ends of which contain a pair of deeper countersunk pockets as shown in FIG. 12 and shown in cross section in FIG. 16. With the fork in the stowed position, Button, Fork, Locking (20) is held in in a nominally outward position in a counterbored pocket (34) by a compression spring (26). With this button in this outward position the fork is unable to rotate around the pivot axis. To release the fork, the user pushes the Button, Locking, Fork (20) inward which moves the button out of the counterbored pocket into a shallower u-shaped pocket (36). The fork is then able to rotate about the pivot axis (35). Once the fork rotates into the deployed position the button is forced outward by the compression spring into the locking counterbore pocket (33) locking the fork in the deployed position which prevents the rasp from rotating during use while inserting the tire plug.

The second of the handles, Handle, Plug holding (17) contains a Tray, Tire Plug Holding (23) which has two pairs of protruding features shown in this embodiment as socket head cap screws. These protruding features sit in a pair of slots in the Handle, Plug Holding (17). The Straight Slot (37) allows the Tray to slide within the Handle, Plug holding. The second pair of protruding features sit in an L-shaped Slot (38) also in the Handle, Plug Holding (23). When the user slides the tray backwards as indicated by the arrow in FIG. 14, the Tray, Tire Plug Holding is able to pivot into an open position as shown in FIG. 15 so the Tire Plugs (22) can be removed.

### Operation

### Preferred Embodiment

### Removing the Debris:

The assembly is nominally in the closed position with the rasp and the fork in the stowed position (FIG. 1) To remove the debris from the tire, the user unfolds the handles (16&17) (FIG. 5) and uses the plier jaws (24&25) to grab and extract the debris.

### Cleaning the Injury:

Once the debris is removed the user presses the Rasp release button (21) and rotates the rasp (18) into the deployed position. The user then refolds the handles into the compact position leaving the rasp deployed (FIG. 7). Next the user grasps the assembly by the pair of closed handles, puts the rasp in the tire injury and moves it in and out of the hole in the tire to clean the injury. Next the user opens the handles, presses the Rasp release button (21) and rotates the Rasp back into the stowed position. (FIG. 1)

Removing a Plug from the Handle:

The user slides the Tray, Tire Plug Holding (23) rearward which allows the Tray to pivot into an open position as shown in FIG. 15. The user can then remove a Tire Plug (22) from the Tray (23).

### Inserting the Plug:

The user presses the Fork Release Button, releasing the fork (19) and rotates the fork into the deployed position (FIG. 6). Next the user takes the Tire Plug (22) removed from the previous step and presses it in the open gap between the tines in the tip of the fork with half of the tire plug on either side of the fork. With the plug inserted in the fork, the user then pushes the fork with the retained plug about into the injury leaving a portion of the tire plug ends on the outside of the tire. The user then removes the fork leaving the plug folded in half inside the hole. The injury in the tire is effectively plugged.

### Trimming the Excess Plug Material:

The user then unfolds the handles, presses the Fork Release Button again, and rotates the fork back into the stowed position. The user then opens the plier jaws and trims the excess plug material with the tire plug cutter (31). This step is important because if too much of the plug material is left outside the tire, the plug can work itself out during driving. Lastly, the user folds the handles back into the compact position (FIG. 1). The tools, now in the compact configuration is easily stowed in a glovebox or pocket.

### CONCLUSION, RAMIFICATIONS AND SCOPE OF INVENTION

Thus the reader will see that at least one embodiment of the tire repair tool provides an easier, all-in-one device for repairing pneumatic car or motorcycle tires without having to remove the tire from the wheel or from the vehicle. Unlike the tools in the prior art, the embodiment described herein contains all the means to:

a) Remove the item which caused the puncture in the tire (nail, screw, etc)
b) Clean the puncture to prepare the injury for the inserted plug
c) Insert a plug to repair the puncture
d) Trim the excess plug material
e) Store additional plugs in the assembly

Additionally, since all these elements are attached to one another, there are no parts to lose while repairing the puncture. While my above description contains many specifics, these should not be construed as limitations on the scope of the invention, but rather as an exemplification of one (or several) preferred embodiment thereof. Many other variations are possible wherein all the aforementioned referenced elements (including, pliers, cutters, a rasp for cleaning a tire puncture, a tool for inserting a tire plug, and a means to store tire plugs within the assembly) critical in repairing a tire are integrated into a single folding assembly. Accordingly, the scope of the invention should be determined not by the embodiment illustrated, but by the appended claims and their legal equivalents.

1) A folding multi-purpose tool comprising:
a) first and second generally channel-shaped handles each having first and second ends, each generally channel-shaped handle; pliers comprising first and second plier halves pivotally mounted to each other, with said plier halves being pivotally mounted to said first ends of said handles; and wherein said folding multi-tool is foldable between a closed, compact configuration and an opened, extended configuration for operating said pliers
b) a tool that is mounted to one of said channel shaped handles which is used to insert a tire repair plug into a damaged tire.

2) The folding multi-purpose tool of claim 1 which includes a rasp for cleaning a puncture in a tire which is pivotally mounted to one of said channel shaped handles.

3) The folding multi-purpose tool of claim 1 with a means to retain tire repair plugs within the channel of one of said channel shaped handles.

4) The folding multi-purpose tool of claim 1 in which the tool to insert the tire repair plug into said tire is a fork.

5) The folding multi-purpose tool of claim 1 with a rasp pivotally mounted to one of the channel shaped handles and which consists of the following:
a) a shallow nominally u-shaped channel at each ends of which there lies a pair of cylindrical counterbores which are deeper than said u-shaped channel
b) a hole lying midway between the two counterbore axes which creates a pivot axis about which the rasp rotates from a stowed position within the channel shaped handle to a deployed position in which it may be used to clean the tire injury.

6) The folding multi-purpose tool of claim 1 in which a fork for inserting tire repair plugs is pivotally mounted to one of the channel shaped handles and which consists of the following:
a) a shallow nominally u-shaped channel at each ends of which there lie a pair cylindrical counterbores which are deeper than said u-shaped channel
b) a hole lying midway between the two counterbore axes which creates a pivot axis about which the fork rotates from a stowed position within the channel shaped handle to a deployed position in which it may be used to insert a tire plug in a tire

7) The folding multi tool of claim 1 that has as the means for locking the rasp as claimed in claim 2 in a deployed position which consists of the following:
a) a flanged release button which is held in a nominally outward position by a spring
b) a shallow u-shaped channel in said rasp in which the flange of said button lies when said button is depressed thus allowing the rasp to rotate about a pivot axis
c) a counterbore in said rasp deeper the said u-shaped channel which lies at one end of the u-shaped channel into which the flanges on the release buttons are forced by said compression spring thus preventing the rasp from rotating about said pivot axis locking the rasp in the deployed position.

8) The folding multi tool of claim 1 that has as the means for locking the tool for inserting tire plugs as claimed in claim 1 in a deployed position which consists of the following:
a) a flanged release button which is held in a nominally outward position by a spring
b) a shallow u-shaped channel in said rasp in which the flange of said button lies when said button is depressed thus allowing the tool to rotate about a pivot axis
c) a counterbore in said tool deeper than the u-shaped channel which lies at one end of the u-shaped channel into which the flanges on the release buttons are forced by said compression spring thus preventing the tool from rotating about said pivot axis locking the rasp in the deployed position.
